(19) United States
(12) Patent Application Publication
(10) Pub. No.: US 2005/0194454 A1
(43) Pub. Date: Sep. 8, 2005

(54) Personal card system featuring integrated circuit

(75) Inventors: Andrew R. Ferber, New York, NY (US); Anthony Gentile, New York, NY (US); John Gentile, Montclair, NJ (US); Terrance Z. Kaiserman, Loxahatchee, FL (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: T-ink, LLC, New York, NY (US)

(21) Appl. No.: 11/052,163

(22) Filed: Feb. 7, 2005

Related U.S. Application Data
(60) Provisional application No. 60/542,314, filed on Feb. 6, 2004.

(51) Int. Cl. G06K 19/06; G06K 5/00

(52) U.S. Cl. 235/492; 235/380

(57) ABSTRACT

A credit card comprises a plastic layer, an integrated circuit (IC) holder for holding a removable electronic device (e.g., processor), and a means for providing power (e.g., a battery). The removable electronic device provides the ability to, at least temporarily, associate status, or promotional, information with the credit card for use in subsequent transactions. The status information is representative of, e.g., eligibility for a discount, preferred buyer status, etc.

### CROSS-REFERENCE TO RELATED APPLICATIONS

This application claims the benefit of the filing date of U.S. Provisional Patent Application No. 60/542,314, filed Sep. 6, 2004, the disclosure of which is hereby incorporated by reference herein.

### BACKGROUND OF THE INVENTION

This invention relates generally to personal cards, such as credit cards, and more particularly to personal cards featuring a detachable electronic component for storing information applicable to transactions for which the cards are used.

The use of personal cards such as credit cards, debit cards, etc., continues to increase. In fact, such increased use is often accompanied by additional benefits to the consumer (customer), such as discounts, preferred customer status, etc. As such, these additional benefits also serve as incentives to further increase use of the personal card such as a credit card.

Unfortunately, such discounts and/or preferred customer status typically involves the consumer having to keep track of yet another type of document, card (e.g., preferred buyer's card), or number, for presentation to a retailer (or merchant, vendor, etc.) in a related transaction. Alternatively, the retailer must initiate another transaction, e.g., a query to another data base storing such customer-related information, to determine if the customer is entitled to a discount, etc.

What is needed is a simple, cost-effective, way of offering personal card associated consumer services.

### SUMMARY OF THE INVENTION

The present invention provides a simple, cost effective, way of offering personal card associated consumer services. Although the invention can be used in conjunction with any kind of personal card, it will be described in the context of a credit card for purposes of clarity of presentation. In light of the description, application of the invention to other types of cards will become apparent.

In accordance with one aspect of the invention, a credit card comprises an integrated circuit (IC) holder and an electronic device for insertion into, and removal from, the IC holder by a user.

In accordance with another aspect of the invention, a credit card comprises a removable electronic device for automatically associating promotional information with a transaction, wherein the promotional information represents discounts, etc., associated with one, or more, services or goods.

In an embodiment of the invention, a credit card comprises a plastic layer, a holder for holding a removable electronic device (e.g., processor including local memory), and a means for providing power (e.g., a battery). The removable electronic device provides the ability to, at least temporarily, associate status information with the credit card. The status information is representative of, e.g., eligibility for a discount, preferred buyer status, etc.

In another embodiment of the invention, the credit card comprises a plastic layer, a SMART chip, a holder for holding a removable electronic device (e.g., a processor), a keypad, an indicator, and a magnetic strip for storing the credit information. The keypad provides the ability to input a code, e.g., an activation number, to the SMART chip as a part authenticating the card for use. The removable electronic device provides the ability to, at least temporarily, associate status information, or promotional information, with the credit card. This information is representative of, e.g., eligibility for a discount, preferred buyer status, etc. As used herein, the term “plastic” is intended to cover various polymers and, thus, should be construed to include polymeric materials of all types.

In another embodiment of the invention, a consumer receives an electronic device, e.g., from a merchant, in association therewith of a service offering. The consumer inserts the electronic device into a credit card such that upon subsequent use of the credit card with the inserted electronic device, the consumer automatically enables the associated service offering.

In another aspect of the present invention, a conductive composition is provided to a credit card substrate. This composition can be applied onto the substrate using existing production equipment by the means of offset printing, screen-printing, flexographic printing, gravure printing, pad printing, ink jet, laser printing, digital printing of all types, bubble jet, letterpress and other methods of applying an ink or coating onto a substrate. It also can be spray coated, dip coated, reverse roll coated, impregnated, saturated, hot stamped, powder coated and virtually applied by every other known application method or combination of methods. This substrate, when attached to electronics, becomes an interactive medium.

Another aspect of the present invention uses membrane switch technology disposed on a surface of the credit card. When activated, an action would commence. This could be in one layer or more than one layer of conductive compositions.

Other activation methods that do not use conductive compositions may also be used. For example, a motion sensor, moisture sensor, temperature sensor, pressure sensor, light sensor, smoke sensor, barometric sensor, magnetic sensor, sound sensor, bend sensor, circuit breaker, odor sensor and the like.

The credit card may further comprise an alerting device, for providing a visual indication and/or an audible indication of status information, e.g., a preferred buyer.

In accordance with another aspect of the invention, an electrical system, e.g., electronics, is provided in the credit card. The electrical system comprises a substrate, an electrical socket (or holder), a conductive composition arranged on a substrate, a power source having a positive terminal and negative terminal wherein the conductive composition is arranged between the positive and negative terminals of the power source for providing power to the electrical socket such that an electrical device can be inserted therein.

The electronics can utilize all existing types of power, both AC and DC, including, but not limited to, batteries, solar cells, generators and alternators. The electronics can utilize all speaker types, circuits and chips of all memory sizes both masked (fixed recording) and re-programmable memory (rewritable recording.)

The electronics can be attached to the credit card substrate by way of glue, heat seal, sonic welding, cold or hot laminating or pressure sensitive adhesive in a permanent or temporary manner. The electronics may be fixed and the conductive compositions may attach in a permanent or non permanent way to the substrate.

Thus, it is an object of the invention to make it easy to allow a merchant, or retailer, to offer credit card associated services.

These and other objects, features and advantages of the present invention will be more readily understood when considered in view of the following detailed description of the preferred embodiments and accompanying drawings.

### BRIEF DESCRIPTION OF THE DRAWINGS

FIG. 1 illustrates one embodiment of a credit card in accordance with the principles of the invention;

FIG. 2 shows an illustrative structure of a credit card in accordance with the principles of the invention;

FIG. 3 illustrates an illustrative block diagram of an system in accordance with the principles of the invention;

FIGS. 4 and 5 show illustrative flow charts in accordance with the principles of the invention;

FIG. 6 shows an illustrative flow chart in accordance with the principles of the invention;

FIG. 7 illustrates another embodiment of a credit card in accordance with the principles of the invention; and

FIG. 8 illustrates another embodiment of a credit card in accordance with the principles of the invention.

FIG. 9 shows a cross-sectional view of a preferred embodiment of a credit card in accordance with the invention.

### DETAILED DESCRIPTION

The present invention is applicable to all kinds of personal cards. Nevertheless, in the interest of brevity the invention will be described in the context of a credit card. As such, for the purposes of interpreting the claimed invention, the term “credit card” is synonymous with “debit card” and the like. In view of the description, application of the invention to other types of cards will become apparent.

The following U.S. patents are hereby incorporated by reference: U.S. Pat. No. 6,188,506 issued Feb. 13, 2001 to Kaiserman et al., entitled “Conductive Color-Changing Ink;” and U.S. Pat. No. 5,567,037, issued Oct. 22, 1996 to Ferber, entitled “LED for Interfacing and Connecting to Conductive Substrates.” In addition, U.S. patent application Ser. No. 09/753,849, filed Jan. 3, 2001, for Kaiserman et al., entitled “Method of Manufacturing Printed Circuit Boards” is hereby incorporated by reference. In addition, the inventive concept is implemented using conventional programming techniques, which are not described herein.

As described further below, a credit card comprises an integrated circuit (IC) holder and an electronic device for insertion into, and removal from, the IC holder wherein the electronic device may comprise a memory and may store information to be used in a transaction.

In one aspect of the invention, the credit card could be comprised of conventional inks presently used in the printing of or molding of paper or plastic materials and a single layer or multiple layer of conductive compositions. Such a composition is both novel and unobvious over materials and systems known in the prior art.

In another aspect of the invention, the credit card comprises one, or more, layers, or substrates, of plastic material. Various coating methods can be used to apply a conductive composition to a surface of one or more of these layers of the credit card. Such coating methods include screen printing, gravure printing, flexographic printing, offset printing, spray coating, knife coating, electrostatic coating, reverse roll coating, ink jet printing, laser printing and various other known printing and coating methods, such as those discussed in U.S. Pat. No. 5,455,749, issued Oct. 3, 1995 to Ferber, entitled “Light, Audio and Current Related Assemblies, Attachments and Devices with Conductive Composition;” U.S. Pat. No. 5,973,420, issued Oct. 26, 1999 to Kaiserman et al., entitled “Electrical System having a Clear Conductive Composition;” and U.S. Pat. No. 5,626,948, issued May 6, 1997 to Ferber et al., entitled “Electrical System having a MultiLayer Conductive Composition;” the subject matter of which have all been incorporated by reference herein. The conductive composition may be a conductive ink either clear or transparent in color, sometimes referred to as water white or, in a visible color that is transparent, translucent or opaque in appearance.

Coatings or printing of conductive compositions may be printed on one side of a substrate, printed on both sides separated by a dielectric material, printed on both sides separated by a material that has a different resistance then the coatings or applied in such a manner as to pass from one side to the other side with continuity.

As an option, “dummy” conductors or circuit elements that are not part of the actual circuitry can be included when the conductive composition is applied in the interest of impeding copying of the actual circuitry. Further, a “dummy layer” of such conductors or circuit elements can be included in the layered structure of the card in order to hide or camouflage the “real” circuitry. Still another, anti-copying measure is to laminate the layers of the card such that any attempt to access an inner layer would result in destruction of that layer.

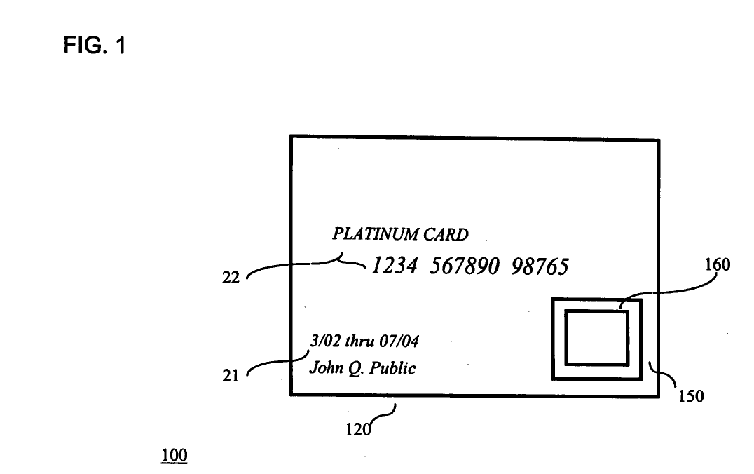

An illustrative credit card 100, in accordance with the principles of the invention, is shown in FIG. 1. Credit card 100 comprises one, or more, substrates as represented by top surface 120. On top surface 120 there is printed (like any conventional credit card) a text portion 22 comprising the card type and account number, along with a text portion 21 comprising the holder's name and validity dates. (It should be noted that, typically, other information, or indicia, also appears on the surface of a credit card, e.g., a “member since” indicator, credit card company name, etc. These are not shown for simplicity.) On the back surface (not shown) is a magnetic strip for storing account number information. In addition, credit card 100 includes IC holder 150 and a removable integrated circuit (IC) 160 or other electronic device (e.g., a processor including local memory, or a memory device), inserted therein.

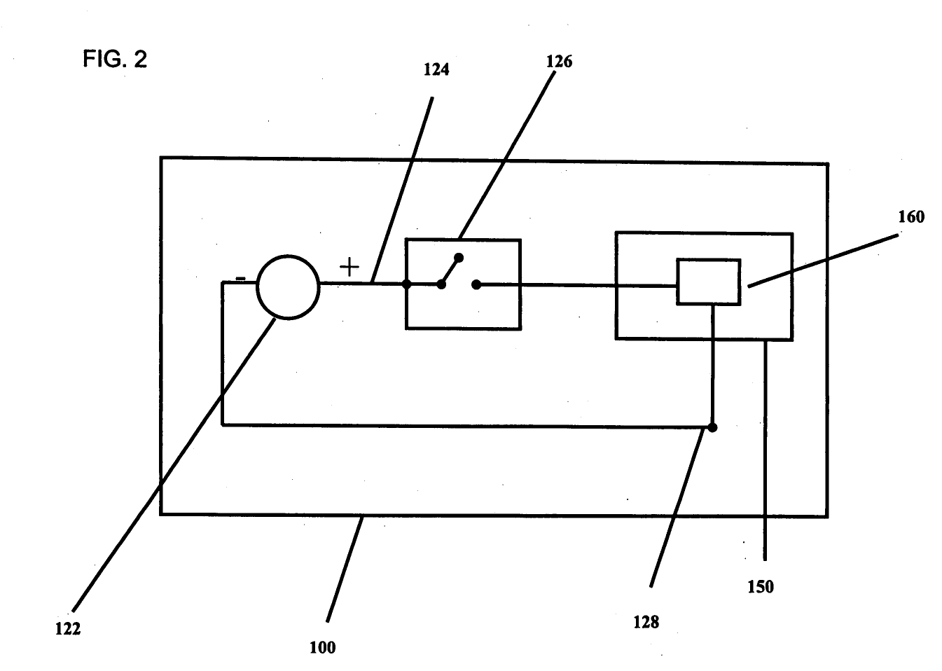

An illustrative structure for a credit card comprising an IC holder is shown in FIG. 2. The structure comprises an IC holder 150 having a receptacle and conductive terminals (not shown) thereon for receiving leads (not shown) of an associated IC 160. A battery 122 is provided for supplying current to the IC via conductive composition supplying current to the IC via conductive composition trace 124 upon activation of switch 126. The circuit is preferably grounded at 128. The battery types that may be used as battery 122 include rechargeable batteries and non-rechargeable batteries. Examples of batteries that may be employed are nickel cadmium batteries, lithium ion batteries, printed batteries and the like. Moreover, a solar cell may be employed in lieu of a battery.

In accordance with one aspect of the invention, removable electronic device (IC) 160 stores therein promotional information, or status information, associated with the user of the credit card that is in addition to information already stored in the magnetic strip. For example, preferred customer status, time-limited discounts, etc. The promotional information stored in electronic device 160 is read out by an associated reader. The latter, other than the inventive concept, is known in the art.

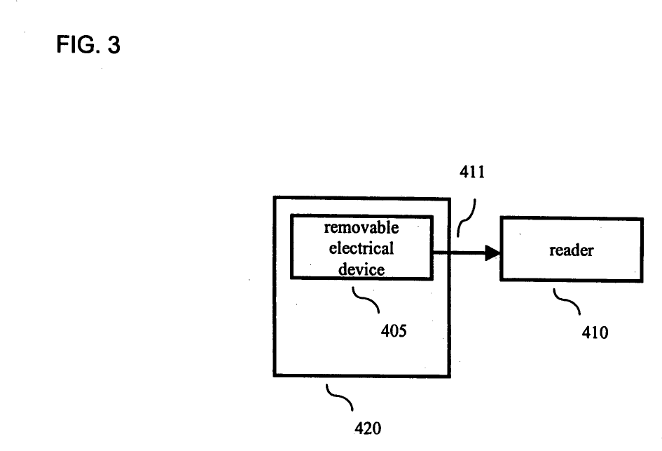

An illustrative block diagram of a system in accordance with the principles of the invention is shown in FIG. 3. A credit card 420 comprises removable electrical device 405. The latter stores promotional and/or user information for use in a credit card transaction. In particular, the promotional information is read out via signal path 411 by reader 410 for use in the transaction. The promotional information illustratively provides for automatic discounting of products or services offered by one or more vendors, etc., and is conveyed in addition to any information provided by the magnetic strip (not shown) of the credit card.

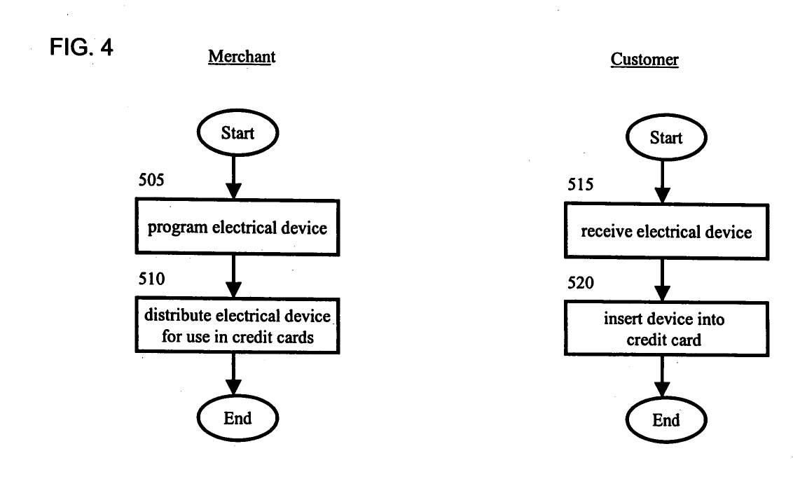

In accordance with another aspect of the invention, an illustrative flow chart is shown in FIG. 4. The ability for the user to insert and remove the electrical device provides the ability for a user to switch—on demand—the kind of promotional information associated with the credit card. For example, a merchant can on a regular basis (e.g., periodically), or on an irregular basis, offer sales, e.g., discounts, on particular goods and/or services. The merchant may identify a list of its customers and distribute to those customers an electrical device storing information associated with the discount (the promotional information) and adapted for insertion into the above-described credit card by the customer when the customer desires to take advantage of the discount. This is illustratively shown by steps 505 and 515 of FIG. 4. In step 505, the merchant programs the electrical device with the requisite promotional information associated with the goods and/or services. In step 510, the merchant distributes, e.g., via the mail, the electrical device with the preprogrammed information to one, or more, customers for them to use simply by insertion into the credit card 100 of FIG. 1. In particular, a customer, in step 515, receives the distribution of the electrical device (e.g., in the mail). This distribution would typically be accompanied by some advertisement literature documenting the offers and benefits of using the attached electrical device. In step 520, the customer inserts the electrical device for use in their credit card, such that subsequent credit card transactions take account of, e.g., the offered discount. (In fact, the customer could accumulate a library of electrical devices (or “chips”), which the customer can insert and remove from the credit card at will to take advantage of different offers from different merchants.)

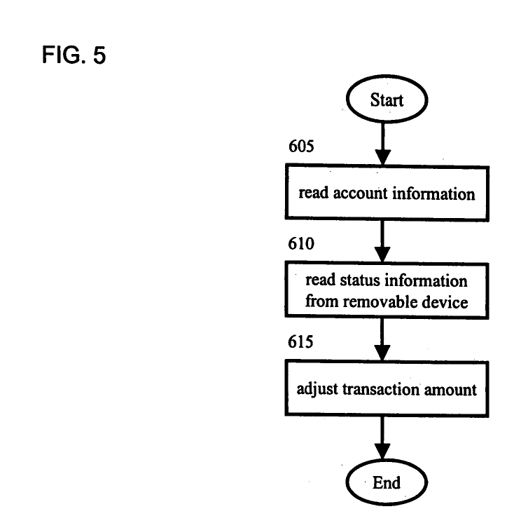

Turning now to FIG. 5, another illustrative flow chart is shown in accordance with the principles of the invention. Once the removable electrical device is attached to the credit card, the information stored therein is available for use in a transaction. This is illustrated in FIG. 5 for an illustrative transaction between a customer and a merchant for charging, or debiting, an amount associated with the transaction (e.g., buying goods (e.g., a book) or services (e.g., renting a car)). Initially, in step 605, the merchant receives the credit card with the removable electrical device and inserts the credit card into a reader for reading account information from the credit card. The account information is used for charging, or debiting, the account the amount associated with the transaction (the transaction amount). However, in step 610, the promotional information stored in the removable electrical device is read by the reader. This promotional information is used in step 615 for adjusting the transaction amount. For example, if the holder of the credit card is a preferred customer, the promotional information may illustratively indicate such a status by applying a ten percent discount to the transaction amount.

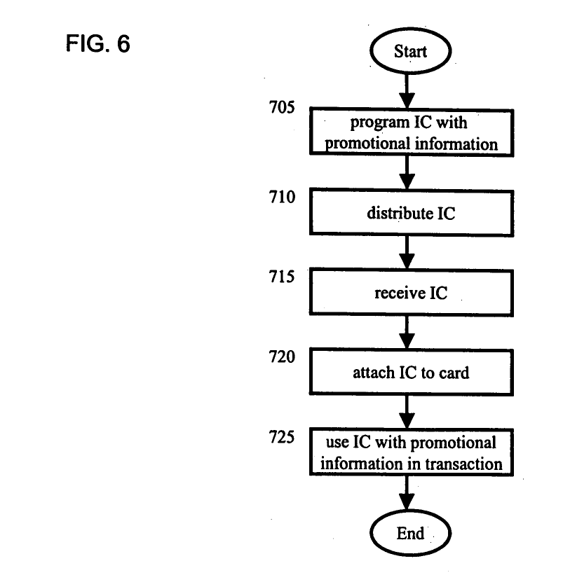

Indeed, as can be observed from above, and in accordance with another aspect of the invention, it is possible to offer benefits and/or promotional information for use in a transaction such that the benefits and/or promotional information is automatically taken into account in the transaction. This is illustrated in the flow chart of FIG. 6. In step 705, an IC is programmed with promotional information associated with goods or services, i.e., the promotional information is stored in the IC. In step 710, the programmed IC is distributed, e.g., via the mail, to a group of users (a user population). The programming and distribution can be performed by one or more individuals (representing themselves or, e.g., a company, etc.). (Indeed, and in accordance with another aspect of the invention, the distribution could also be in electronic form such that the user programs the IC, e.g., via their personal computer.) The user population can be selected in any number of ways, e.g., pre-selected based on other criteria-related information and/or random (e.g., to “occupant”), etc. Criteria-related information can be in any form, e.g., market-based data, buying habits, amount of previous goods, or services, purchased (a preferred buyer)), identified from predetermined mailing lists (these can be purchased), targeting specific market areas, cities, age-groups, etc. The distribution could be on a regular (e.g., every month) or irregular basis. In step 715, the programmed IC is received by the user, who attaches the programmed IC to a credit card in step 720. The credit card with attached IC is now available to automatically take advantage of the programmed promotional information stored therein in a transaction in step 725. Thus, and in accordance with an aspect of the invention, it is possible to offer an enhanced-form of transaction wherein promotional information is automatically taken into account in a credit card transaction.

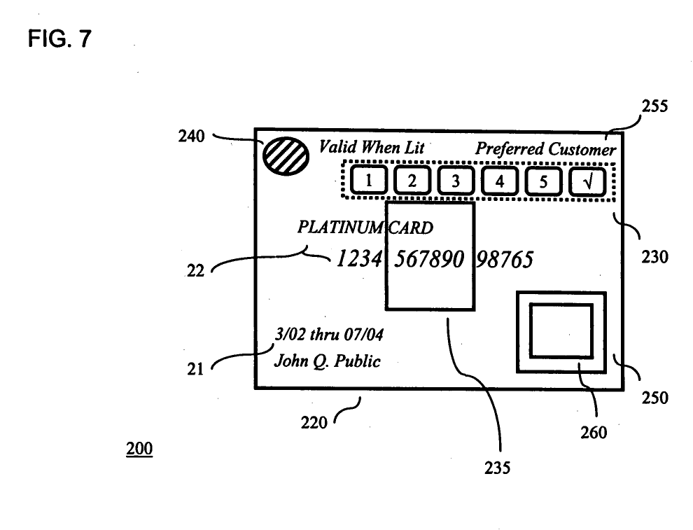

Another illustrative credit card 200, in accordance with the principles of the invention, is shown in FIG. 7. Credit card 200 comprises one, or more, substrates as represented by top surface 220. On top surface 220 there is printed (like any conventional credit card) a text portion 22 comprising the card type and account number, along with a text portion 21 comprising the holder's name and validity dates. (It should be noted that, typically, other information, or indicia, also appears on the surface of a credit card, e.g., a “member since” indicator, credit card company name, etc. These are not shown for simplicity.) In addition, credit card 200 includes a “SMART chip” 235 and, as such, is a form of smart credit card. The SMART chip 235 provides additional security as known in the art and, e.g., is capable of performing cryptographic functions such as creating or checking a digital signature for authenticating, via a reader, the cardholder or user. Finally, and in accordance with the principles of the invention, credit card 200 comprises IC holder 250 for holding an electrical device 260, as described above. That is, electrical device 260 stores therein status, or promotional information.

In accordance with another aspect of the invention, credit card 200 also comprises, on top surface 220, an input device 230 and an alerting device 240 (along with an optional text caption “Valid When Lit”).

As shown in FIG. 7, input device 220 is illustratively a keypad comprising 5 keys. These keys are implemented using, e.g., conductive touch-sensitive ink as described in above-mentioned U.S. Pat. No. 5,626,948, membrane switches, pressure switches, bend and/or flex sensors, buttons or other known activation devices. Either a human touch or another object touching these switches would actuate the switch. The keypad can be used for entering additional information, such as, but not limited to, a customer code, or personal identification number (PIN) code.

Alerting device 240 is illustratively a portion of top surface 240 comprising thermochromic ink, i.e., with an electronic color change capability. The latter is described in above-mentioned U.S. Pat. No. 6,188,506. Alerting device 240 is illustratively controlled by SMART chip 235. Alternatively, alerting device 240 may be present on, e.g., credit card 100 (described earlier) and may be controlled via the reader.

As described above, a smart card provides additional security features. In contrast, and in accordance with one aspect of the invention, it is also possible to provide transaction-based features via attached electrical device 260. For example, SMART chip 235 reads the promotional information stored within electrical device 260 during a transaction, e.g., to take advantage of any discounts etc. In addition, SMART chip 235 may also, in response to the status information stored in the electrical device, indicate on other surface portions of credit card 200 a visible indication (e.g., through the use of thermochromic ink) specific and/or generic text labels, such as, but not limited to, “Preferred Customer” as indicated by text portion 255.

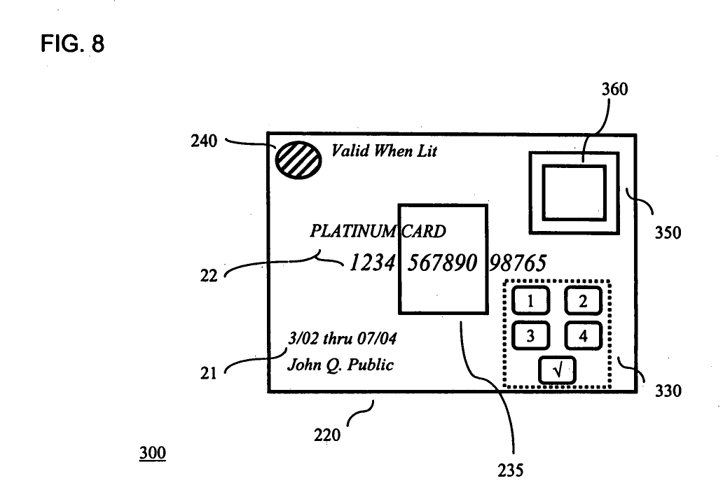

Turning now to FIG. 8, a different arrangement of a credit card in accordance with the principles of the invention is shown. Credit card 300 is similar to credit card 200 of FIG. 7 except for the location, shape and size of the input device. As such, like numbers indicate similar elements and are not described further. In credit card 300, an input device 330 is arranged along a lower right portion of surface 220. In addition, an IC holder 150 for holding an electrical device 360 is positioned along the top right corner of credit card 300.

In accordance with an aspect of the invention, a personal identification number (PIN) code is programmed a priori into the SMART chip (e.g., its memory). Alternatively, conductive ink is used to print a conductive pattern with numerous pairs of resistors and conductors on a substrate of the credit card. Each resistor/conductor pair is tied between a positive voltage and ground such that a predefined logic level, or state, can be associated therewith. Disabling, or blowing, one element of the pair, e.g., the conductor, causes the logic level to change to another state. In this way, a PIN code can be a priori set in the credit card before distribution.

In order to authenticate use of the card, the user must first enter the PIN code, via the input device. As such, the SMART chip receives a sequence of k digits from a set of K digits. (In the context of FIG. 8, K=4; while in FIG. 7, K=5.) The end of the k digit sequence is represented by use of the “√” key. This is the “entered PIN code.” After the end of the sequence has been detected by the SMART chip, a comparison is made to the stored PIN code. If the correct PIN code has been entered, the SMART chip enables the alerting device such that the alerting device turns a predefined color to indicate the holder of the credit card is an authorized user of the card. In addition, the SMART chip initiates a timer. Upon expiration of the timer, the SMART chip disables the alerting device such that the predefined color is no longer shown by the alerting device. The thermochromic ink is used to show semi-permanent color changes and/or text.

If the entered PIN code does not match the stored PIN code—nothing happens. Alternatively, the SMART chip can de-actuate the card. For example, the SMART chip can trigger another portion of the alerting device, or a different alerting device, to indicate that the card may not be in the possession of an authorized user by showing a different color. As an option, access to the information on an inserted IC can be blocked. As yet another variation, the SMART chip can keep track of the number of incorrect attempts and, if a predefined number is reached (within or without a predefined time period), trigger another portion of the alerting device, or a different alerting device, to indicate that the card may not be in the possession of an authorized user by showing a different color. Similarly, electronics could be added to wipe the magnetic strip of account information, or erase the PIN code from memory, after a predefined number of incorrect attempts within, or without, a predefined time period.

In accordance with an aspect of the invention, the above-described authentication device and method can be used to activate, actuate, or de-actuate, a credit card and to verify in the presence of a merchant an authorized user of the credit card. Although the illustrative credit card was shown with one alerting device—the alerting device can have more than one type of thermochromic portion (e.g., with different color definitions), or more than one alerting device can be used, to separately show a valid activation and valid authentications.

Other variations are possible. For example, the alerting device can comprise a blowing agent, such that self-embossing or self de-embossing occurs as a function of the authentication of the user. In addition, instead of thermochromic ink as the alerting device, a surface mounted LED (light emitting diode) may be used that will light up upon entry of a correct PIN code thereby authenticating the user to the retailer. Alternatively, or in addition to, the alerting device may generate an audio signal (i.e., a sound) appropriate to the authentication status of the user.

As described above, one aspect of the invention provides the ability to make credit cards resistant to counterfeiting while at the same time being easily authenticated and verified without entailing a significant cost increase in manufacturing. In addition, another aspect of the invention makes it easy to allow a merchant, or retailer, to validate a card on-site.

As noted above, conductive compounds may be used. A conductive compound may be of any color, formulation type and conductivity range. Further, a conductive compound, by way of example, may comprise polyesters, polyamides, poly vinyl alcohol, poly vinyl acetate, poly vinyl chloride, alkyds, phenolics, acrylics and/or polyurethanes or any combination thereof for as a binder system. In addition, a conductive compound, by way or example, may utilize all known conductive materials including but not limited to, carbon, graphite, silver, gold, platinum, palladium, nickel, stainless steel, other conductive metals, conductive polymers, acids, salts, glycols, water or antistats of all known types including combinations of conductive materials. Additives to a conductive compound may utilize any known humectants, solvents, pigments, wetting agents, thickeners, fillers or combination of materials.

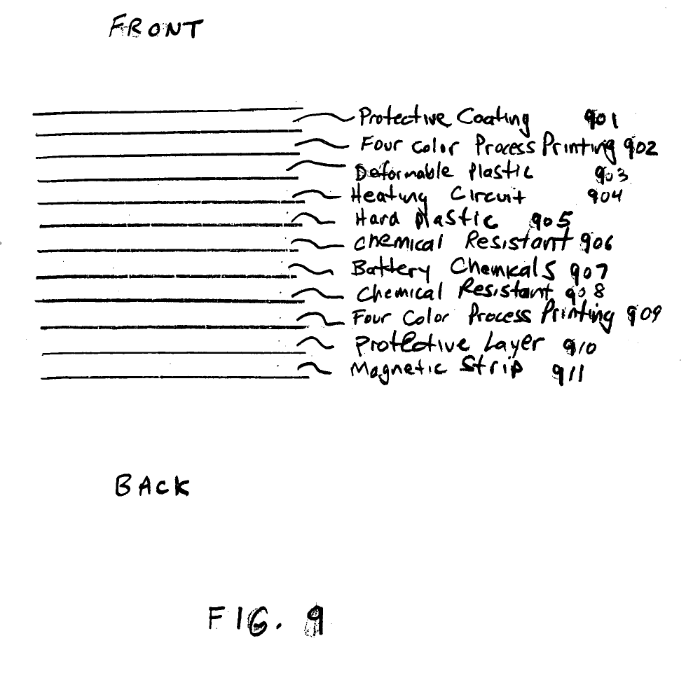

Turning to FIG. 9, there is shown a cross-sectional view of a preferred embodiment of a credit card in accordance with the invention. The figure is oriented such that the front of the credit card is facing the top of the page and the back of the credit card is facing the bottom of the page. The thickness of the layers has been greatly exaggerated and the relative thicknesses of the layers have not been preserved.

As can be seen from the figure, the card consists of 11 layers. From the top down, the card includes a protective layer 901 over a layer that includes four color process printing 902. Under the printing layer 902 lies a layer of deformable plastic 903 that, in turn, lies over a heating circuit layer 904 and a layer of hard plastic 905. The combination of the deformable plastic layer 903, heating circuit layer 904 and hard plastic layer 905 can be used to implement the self-embossing feature of the invention. More specifically, a portion of the deformable plastic may be deformed in response to directed heat generated by heating circuitry in layer 904.

Beneath hard plastic layer 905 is a chemically resistant layer 906, a battery chemicals layer 907 and a chemically resistant layer 908. The chemically resistant layers 906 and 908 contain the battery chemicals. The battery chemicals layer 907 may include one or more sub-layers, such as an anode layer and cathode layer. In any event, the battery chemicals layer is used to form a dry cell battery, wet cell battery or the like, and provides power for the circuits on the card.

Below chemical resistant layer 908 is a second layer having four color process printing 909. Under layer 909 is a protective layer 910. A magnetic strip layer 911 lies under protective layer 910 and, in a preferred embodiment, does not extend over the full surface of protective layer 910. That is, the magnetic strip may cover only a narrow swath of protective layer 910.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An improved credit card for use in a transaction, the improvement comprising:
an integrated circuit holder that enables user insertion and removal of an electrical device to the credit card, wherein the electrical device stores information for use in the transaction.

2. A credit card comprising:
a removable electrical device for storing promotional information; and
an integrated circuit holder for attaching the removable electrical device to the credit-card, wherein when the removable electrical device is attached to the credit card, the stored promotional information is available for use in a transaction.

3. The credit card of claim 2 further comprising a layer of conductive ink that is coupled to the integrated circuit holder for use in reading the stored promotional information.

4. A method for use with a credit card, the method comprising the steps of:
receiving a removable electrical device having stored therein information associated with a good or service; and
attaching the removable electrical device to the credit card such that the stored information is available for use in a transaction.

5. A method for use with a credit card, the method comprising the steps of:
selecting one of a number of removable electrical devices, each device having stored therein information associated with a particular good or service; and
attaching the selected one of the number of removable electrical devices to the credit card such that the stored information is available for use in a transaction related to the associated particular good or service.

6. A method for use with a credit card in a transaction, the method comprising the steps of:
reading account information from the credit card for determining therefrom an account to charge, or debit, for an amount associated with the transaction;
reading status information from a removable electrical device of the credit card; and
adjusting the amount to charge or debit as a function of the read status information.

7. A method comprising the steps of:
programming an electronic device with promotional information;
distributing the programmed electronic device;
attaching the programmed electronic device to a credit card;
using the credit card with the attached programmed electronic device in a transaction such that the promotional information programmed therein is available for use in the transaction.

8. The method of claim 7 wherein the using step causes an initial transaction amount to be modified as a function of the programmed promotional information in the attached programmed electronic device.
